(19) United States
(12) Patent Application Publication
(10) Pub. No.: US 2025/0176071 A1
(43) Pub. Date: May 29, 2025

(54) CONTROL DEVICE

(71) Applicant: TOYOTA JIDOSHA KABUSHIKI KAISHA, Toyota-shi (JP)

(72) Inventor: Hayato MIZUMA, Tokyo (JP)

(73) Assignee: TOYOTA JIDOSHA KABUSHIKI KAISHA, Toyota-shi (JP)

(21) Appl. No.: 18/775,328

(22) Filed: Jul. 17, 2024

(30) Foreign Application Priority Data
Nov. 24, 2023 (JP) 2023-199473

(51) Int. Cl. H04W 88/06

(52) U.S. Cl. CPC H04W 88/06

(57) ABSTRACT

A control device for a vehicle, wherein the control device includes a control unit, a communication unit, and a storage unit, and the control unit performs an operation including setting a token related mode related to token transfer to a vehicle, communicating with another vehicle or another device via a communication unit according to the token related mode, and executing token transfer between the vehicle and another vehicle or another device.

### CROSS-REFERENCE TO RELATED APPLICATION

This application claims priority to Japanese Patent Application No. 2023-199473 filed on Nov. 24, 2023, incorporated herein by reference in its entirety.

### BACKGROUND

### 1. Technical Field

The present disclosure relates to a control device.

### 2. Description of Related Art

Conventionally, there is known a technique of being given way through vehicle-to-vehicle communication (see U.S. Patent Application Publication No. 2018/0082590, for example). Specifically, the host vehicle is given way by giving a token of a blockchain technique to a slow vehicle ahead, by using a system called a Cooperatively Managed Merge and Pass (CMMP) token.

### SUMMARY

In the above background art, there is room for improvement from the viewpoint of smoothly promoting the giving action.

The present disclosure has been made in view of the above circumstances, and an object of the present disclosure is to smoothly promote the giving action.

An aspect of the present disclosure provides
a control device for a vehicle, in which
the control device includes a control unit, a communication unit, and a storage unit, and the control unit executes operation including:
setting the vehicle to a token-related mode related to exchange of a token; and
communicating with another vehicle or another device via the communication unit and exchanging a token between the vehicle and the other vehicle or the other device according to the token-related mode.

According to an embodiment of the present disclosure, it is possible to smoothly prompt the giving action.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram of an information processing system;

FIG. 2 is a block diagram illustrating a configuration of a vehicle;

FIG. 3 is a diagram illustrating a data structure of a holding token count table;

FIG. 4 is a diagram illustrating a data structure of a transfer action table;

FIG. 5 is a flow chart illustrating an operation performed by the information processing system when the first token-related mode is set; and

FIG. 6 is a flowchart illustrating an operation performed by the information processing system when the second token-related mode is set.

### DETAILED DESCRIPTION OF EMBODIMENTS

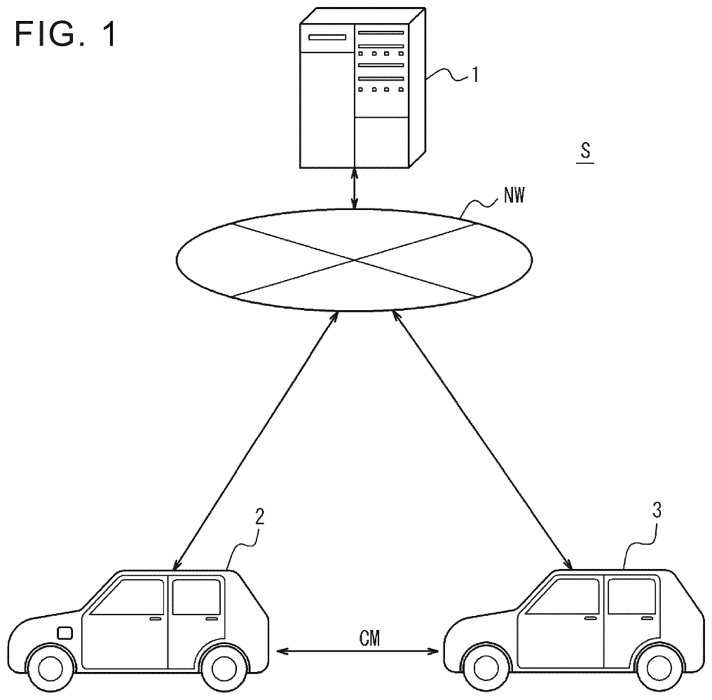

FIG. 1 is a schematic diagram of an information processing system S according to the present embodiment. The information processing system S includes an information processing device 1, a vehicle 2, and another vehicle 3 that can communicate with each other via a network NW. The network NW includes, for example, a mobile communication network, a fixed communication network, or the Internet.

In FIG. 1, for convenience of explanation, the information processing device 1, the vehicle 2, and the other vehicle 3 are illustrated one by one. However, the number of the information processing device 1, the vehicle 2, and the other vehicle 3 is not limited to this. For example, the processes executed by the information processing device 1 according to the present embodiment may be executed by a plurality of the information processing devices 1 disposed in a distributed manner. In the present embodiment, the vehicle-to-vehicle communication CM can be executed directly or indirectly between the vehicle 2 and the other vehicle 3.

The information processing device 1 is installed in facilities such as a data center. The information processing device 1 is, for example, a computer such as a server belonging to a cloud computing system or other computing systems.

The vehicle 2 and the other vehicle 3 include any type of motor vehicle, such as, for example, a gasoline-powered vehicle, a diesel-powered vehicle, a HEV, PHEV, BEV, or a FCEV. The term “HEV” is an abbreviation for “hybrid electric vehicle”. The term “PHEV” is an abbreviation for “plug-in hybrid electric vehicle”. The term “BEV” is an abbreviation for “battery electric vehicle”. The term “FCEV” is an abbreviation for “fuel cell electric vehicle”. The vehicle 2 and the other vehicle 3 are driven by a driver.

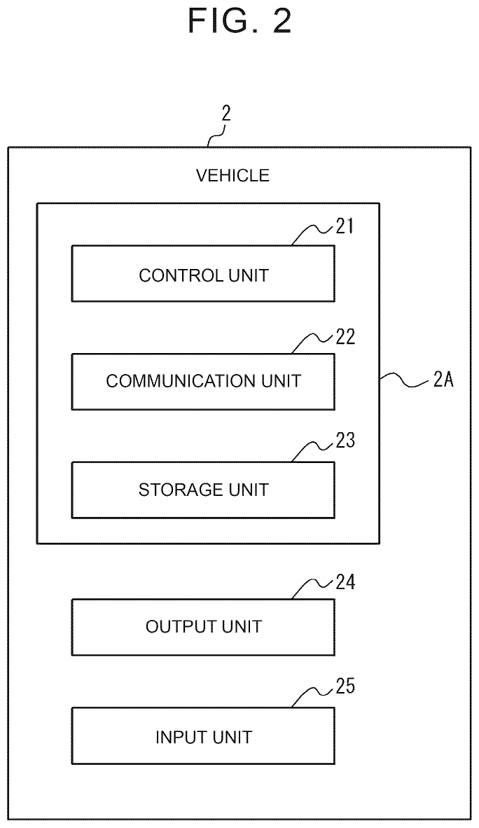

The internal configuration of the vehicle 2 will be described in detail with reference to FIG. 2. The vehicle 2 includes a control device 2A, an output unit 24, and an input unit 25. The control device 2A includes a control unit 21, a communication unit 22, and a storage unit 23. The components of the vehicle 2 are communicatively connected to each other.

The control unit 21 includes one or more general-purpose processors including, for example, a central processing unit (CPU) or a micro processing unit (MPU). The control unit 21 may include one or more dedicated processors specialized for a specific process. The control unit 21 may include one or more dedicated circuits instead of a processor. The dedicated circuit may be, for example, a field-programmable gate array (FPGA) or an application-specific integrated circuit (ASIC). The control unit 21 may include an electronic control unit (ECU). The control unit 21 transmits and receives arbitrary information via the communication unit 22.

The communication unit 22 includes a communication module for connecting to a network NW. The communication unit 22 may include modules corresponding to one or more mobile communication standards including long term evolution (LTE), 4th generation (4G), or 5th generation (5G). Communication unit 22 may include Bluetooth (registered trademark), AirDrop (registered trademark), IrDA, ZigBee (registered trademark), Felica (registered trademark), or communication modules corresponding to one or more standards or specifications of near-distance communication including RFID. The communication unit 22 transmits and receives any data via a network NW.

The storage unit 23 includes, for example, a semiconductor memory, a magnetic memory, an optical memory, or a combination of at least two types thereof, but is not limited thereto. The storage unit 23 may function, for example, as a main storage device, an auxiliary storage device, or a cache memory. The storage unit 23 may store information of a result analyzed or processed by the control unit 21. The storage unit 23 may store various kinds of information related to the operation or control of the vehicle 2. The storage unit 23 may be provided outside the vehicle 2 and may be accessed from the vehicle 2.

The output unit 24 is, for example, a display. Instead of being provided in the vehicle 2, the output unit 24 may be connected to the vehicle 2 as an external output device. As a connection method, for example, any method such as a USB (registered trademark), an HDMI (registered trademark), or Bluetooth (registered trademark) can be used. The term “USB” is an abbreviation for “universal serial bus”. The term “HDMI (registered trademark)” is an abbreviation for “high-definition multimedia interface”. The output unit 24 may be a touch panel. The output unit 24 may be a speaker or the like that outputs information by voice.

The input unit 25 is, for example, a microphone, a physical key, a capacitive key, a pointing device, or a touch screen integrally provided with a display. The input unit 25 receives an operation of inputting information used for the operation of the vehicle 2. Instead of being provided in the vehicle 2, the input unit 25 may be connected to the vehicle 2 as an external input device.

The hardware configuration of the information processing device 1 may be the same as the hardware configuration of the control device 2A. The hardware configuration of the other vehicle 3 may be the same as the hardware configuration of the vehicle 2.

Hereinafter, an outline of an information processing method executed in the information processing system S will be described.

### 1. Conditions for Incentive Acquisition

When a communication or transfer action is performed using vehicle-to-vehicle communication, the user of the vehicle 2 or the vehicle 2 acquires an incentive. Specifically, an incentive is obtained in the following cases.
(1) Transfer behavior through inter-vehicle communication
   When a determination is made to transfer the road by receiving a request from the other vehicle 3 by communication, such as in the case of a lane change, merging, passing, or turning right and left
   When the presence of the other vehicle 3 entering the crossing road from the facility outside the road is received by communication, and the vehicle stops to give way to the vehicle 3
   When a clear intention is sent as a message, for example, when passing through a narrow road
(2) Risk Avoidance Through Vehicle-To-Vehicle Communication
   When giving way is requested to contribute to avoiding forceful cutting in
   When the presence of the vehicle 2 is notified to the other vehicle 3 outside the line of sight
(3) Thank you by car-to-car Communication
(4) Apologies through vehicle-to-Vehicle communication
(5) Contributing to Eco through Vehicle-to-Vehicle Communication
(6) Communication with the traffic-vulnerable
(7) Encouragement by vehicle-to-vehicle communication

In the present embodiment, a case where inter-vehicle communication is performed will be described for convenience of explanation. Alternatively, however, communication may take place between the vehicle 2 and a device operated by a light vehicle or a pedestrian.

### 2. Penalty Conditions

A penalty may be given to the user of the vehicle 2 when an action is taken that does not contribute to safe driving or to fostering a traffic culture.

### 3. Types of Incentives And Means of Granting

The incentive granted to the user includes a token. Embodiments in which tokens are provided are described in detail below.

### 4. Contents of Data Stored in Information Processing Device 1 or Storage Unit 23

The contents of the data stored in the information processing device 1 or the storage unit 23 are shown below.
(1) Vehicle probe data collected from pre-existing DCM
(2) Basic information of the communicating party (for example, ID of the other party's vehicle, the vehicle speed, the position information, etc.)
(3) Content of communication
(4) Assignment action related information (for example, assignment vehicle ID, assignment action type ID, action occurrence place information (position, intersection information), assignment action occurrence time, and an index corresponding to the communication service ID)

Examples of indicators for communications-service ID are as follows:
In the case of lane change or transfer at the time of merging, the distance between vehicles, deceleration, lane change completion time, etc.
In the case of an encounter approaching notification, the brake reaction time, stop position, deceleration, etc.

### 5. Communication Method in Information Processing System S

A communication method in the information processing system S will be described below.
(1) Information is indirectly transmitted and received between the vehicle 2 and the other vehicle 3 via the information processing device 1 by using a mobile carrier line or the like mounted on the vehicle 2 or the other vehicle 3.
(2) An Internet line of a mobile terminal connected to the vehicle 2 or the other vehicle 3 is used.
(3) The information is transmitted to the roadside device by the road-to-vehicle communication, and the information is indirectly transmitted to the other vehicle 3 via the roadside device, the Internet, and the like. The frequency band of the road-to-vehicle communication is the same frequency band as the inter-vehicle communication or a frequency band different from the inter-vehicle communication.
(4) In the frequency band of the inter-vehicle communication, information is directly transmitted and received between the vehicle 2 and the other vehicle 3.

### 6. Association Between Vehicle Information and User Information

The association between the vehicle information and the user information is described below.
(1) When a user terminal (for example, a smart phone) is connected to the vehicle 2, the vehicle ID and the user data are associated with each other in the dedicated application.
(2) QR code representing the vehicle ID is displayed on the output unit 24 of the vehicle 2, and QR code is read by using the dedicated application of the user terminal, thereby performing association.
(3) When riding on the vehicle 2, user ID specific to the user is input to the input unit 25 of the vehicle 2.

### 7. Type of Communication

The types of communication are shown below.
(1) Warning: Warning of encounters, support for right-to-left turns, and notification of approaching of traffic weak people
(2) Informational: Notification of approach or presence (e.g., XX is approaching, XX is waiting for entry, etc.), request for assignment (please let my car go ahead of your car, etc.), assignment signal (please go ahead, etc.)

### 8. Communication Interface

Communication interface is described below.
(1) Display of messages such as thanks, apologies, greetings, or likes at the output unit 24
(2) Voice representation
(3) Highlight Message Sender

### 9. Details of Method of Processing Information Related to Token

An information processing method in a case where a token is transmitted and received will be described in detail. Here, the electronic token is exchanged between the plurality of vehicles by communication, thereby prompting the user who drives the vehicle 2 or the other vehicle 3 to take the transfer action. The tokens to be exchanged may be distributed in an electronic manner from the enterprise side or the service provider side, such as a finished vehicle manufacturer or an insurance company. Alternatively, the token may be purchased by the user, generated by mining, etc. The user of the vehicle 2 can transmit the token to the counterpart user in a state of holding the token in order to convey a gratitude during driving or request the transfer driving. Since the token received from the user of the other vehicle 3 is his/her own, the user of the vehicle 2 can make a transfer request to another user using the received token.

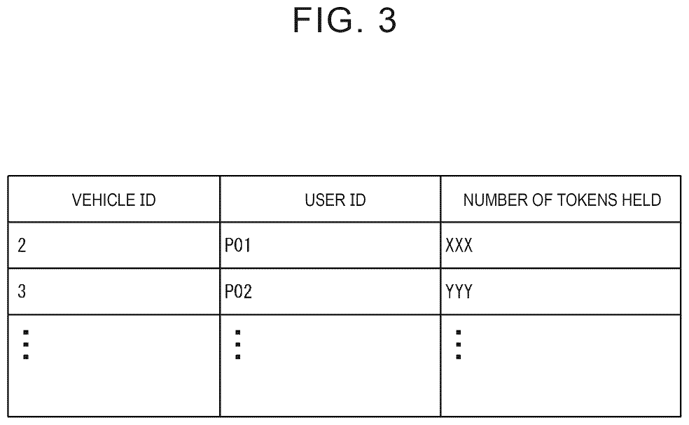

As shown in FIG. 3, the number of owned tokens is stored in association with the vehicle ID of the respective vehicle. As an additional or alternative, the number of tokens held may be stored in association with the user ID of the respective user. The driver of the vehicle 2 is a user P01. The driver of the other vehicle 3 is a user P02.

The user of the vehicle 2 can set any of the following token-related modes regarding the transfer of tokens via the input unit 25 of the vehicle 2 before driving or during driving.

First token related mode: A mode indicating that a route is preferentially given on condition that a token is transmitted to the other vehicle 3
Second token-related mode: A mode that indicates that the route is given priority on condition that the token is sent.
Third token related mode: A mode indicating that it is difficult to give a way to send a token Fourth token related mode: a mode indicating that a token is transmitted if a token is requested when a route is given, or a route is given if a token is transmitted

The token-related mode can be arbitrarily set as long as it indicates the mental state of the driver, driving skill, or the like. The setting contents are stored in the storage unit 23 or the information processing device 1.

For example, the first token-related mode indicates that the user P01 of the vehicle 2 is in a hurry. Vehicle 2 in which the first token related mode is set, when requesting the transfer to the other vehicle 3 in the vicinity by the vehicle-to-vehicle communication, by transmitting to give the request from sending the token owned by itself, it is possible to urge the transfer driving by the other vehicle 3. In this case, it is up to the driver of the other vehicle 3 whether or not the other vehicle 3 transfers the road to the vehicle 2.

The second token-related mode indicates that the user P01 is driving a bottle. The vehicle 2 in which the second token-related mode has been set must transfer the road on condition of token transfer when a request for transfer is received from the surrounding vehicle in the inter-vehicle communication. When a request for transfer is received from the other vehicle 3 in which the first token related mode is set, the vehicle 2 automatically accepts the request. In a case where a request for transfer is received from the other vehicle 3 in which the first token related mode is not set, the vehicle 2 may transmit a message requesting a token to the other vehicle 3. When accepting a request from the other vehicle 3, the vehicle 2 always performs a transfer action. When the vehicle 2 does not perform the transfer action while accepting the request by receiving the token from the other vehicle 3, a penalty (i.e., a penalty) is given to the vehicle 2. As an alternative example, the vehicle 2 may automatically perform the transfer action according to the surrounding situation by automatic driving.

The third token-related mode indicates that the user P01 is a beginner and cannot afford to drive, or that the user P01 is in a bad mood and does not want to give the way, etc.

The fourth token-related mode indicates that it does not strongly request token transmission but has to receive a token.

The set token related mode is stored in the storage unit 23 of the vehicle 2. Additionally or alternatively, the token related mode may be stored in the information processing device 1 in association with the vehicle 2.

The vehicle 2 transmits a token to the other vehicle 3 via the communication unit 22 in a case where the other vehicle 3 performs a transfer action. The transmitted token is stored in the other vehicle 3. Additionally or alternatively, the token may be stored in the information processing device 1 in association with the other vehicle 3.

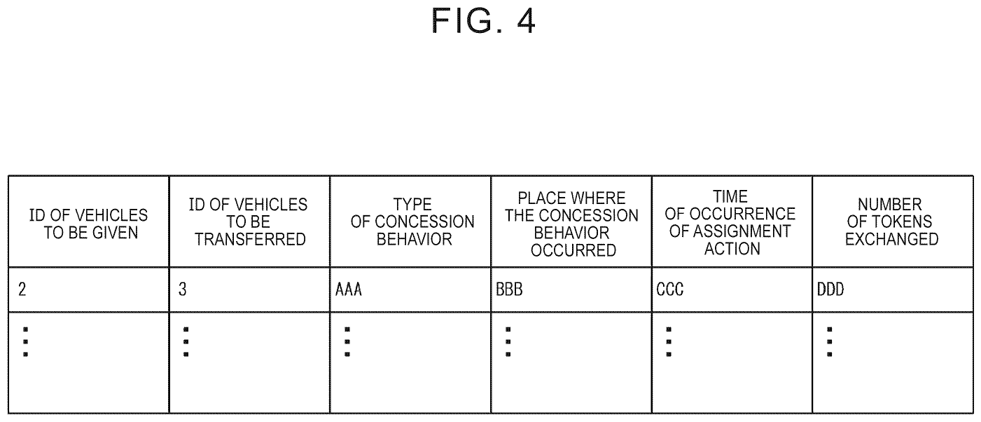

As illustrated in FIG. 4, when the transfer action is performed, at least one of the following information may be stored in the information processing device 1 in association with each other.
ID of vehicle giving way
ID of vehicle being given way
Type of behavior to give way
Location where the behavior to give way occurred (location information, intersection information, etc.)
Time of occurrence of behavior to give way
Number of tokens exchanged

The vehicle 2 may set a minimum level for the amount of tokens to be transmitted and received, but may not set an upper limit. A preset amount of tokens may be sent on the user side. The setting contents are stored in the vehicle 2. As an additional example or as an alternative, the settings may be stored in the information processing device 1 in association with the vehicle 2.

The number of tokens owned by each vehicle is stored in a storage unit of each vehicle. As an alternative, the number of tokens owned by each vehicle may be stored in the information processing device 1 in association with each vehicle.

Upon determining the number of tokens owned by the vehicle 2, the vehicle 2 may limit the settable token-related mode among the plurality of token-related modes according to the number of tokens owned. For example, if the number of owned tokens falls below a preset reference value, or if the vehicle 2 does not own a token, the vehicle 2 cannot request a transfer and set at least some token-related modes. As an additional example or as an alternative, the vehicle 2 may cancel the set token-related mode when it detects that the number of tokens owned by the vehicle 2 has fallen below a reference value during driving. In this case, the token-related mode is not reset until it is reset to the user after the next stop of the vehicle 2 (i.e., IG-OFF condition). Alternatively, the token-related mode may transition to a state in which only the reception of the token is possible, and may automatically transition to the first token-related mode if the token again exceeds a preset value during driving by inter-vehicle communication. In this case, the vehicle 2 can transmit the token again and transmit the transfer request. With this configuration, the vehicle 2 can suppress the inconsistency that there is no token to be transmitted while the vehicle 2 promises to transmit the token.

The vehicle 2 can notify the user PO1 of the reception or transmission of the token by a notification sound or a screen-display via the output unit 24. When receiving a token transmission request from the other vehicle 3 in which the second token related mode is set, the vehicle 2 may perform token transfer interruption processing in a normal inter-vehicle communication service sequence. When exchanging tokens, the vehicle 2 transmits not only a vehicle ID but also a message requesting a wallet ID or the like to the other vehicle 3 when the token has a property of a virtual currency. This interruption process is set at a lower priority than a notification with a higher urgency, such as an emergency warning of approaching the surrounding vehicle.

The vehicle 2 may visualize the token-holding status of the surrounding other vehicle 3 with respect to the user PO1 on the display screen or the like in the output unit 24.

Due to the malfunction of the inter-vehicle communication, there is a possibility that a situation may occur in which the token is promised to be transmitted and received but the token is not received, or a reply indicating the intention of transfer has not reached the other party. In this case, when the vehicle 2 is performing the inter-vehicle communication via the network communication of the cellular line, since the vehicle ID of the communication partner can be held at the time when the handshake of the communication is possible, the communication is resumed again to the vehicle ID when the communication status is restored. With this configuration, the vehicle 2 can suppress leakage of token transfer or the like. On the other hand, when the vehicle 2 performs inter-vehicle communication using direct communication between vehicles, it may be difficult to restore the communication state. However, the vehicle 2 may transmit a token via the Internet when connected to a road-to-vehicle communication infrastructure or the like that can be connected to a network. As an additional example or as an alternative, the vehicle 2 may record in the storage unit 23 that the token could not be successfully transmitted in the direct communication between the vehicles, and may transmit the record to the information processing device 1 via the Internet. With this configuration, the vehicle 2 can receive follow-up measures such as a guarantee from a manufacturer or the like later.

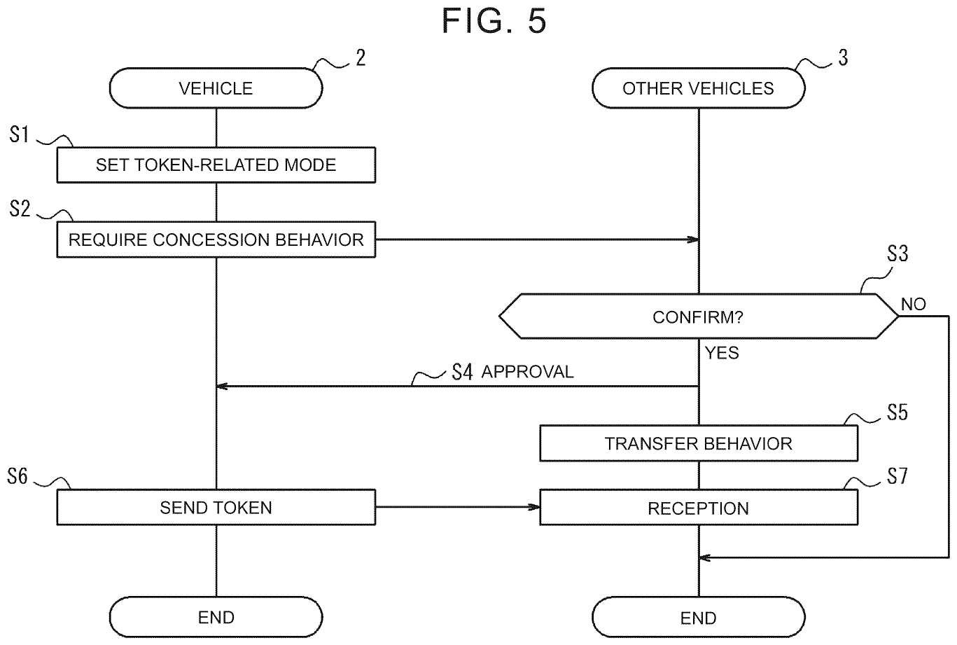

In FIG. 5, a flowchart illustrating an operation performed by the information processing system S when the first token related mode is set in the vehicle 2 will be described.

In S1, the vehicle 2 sets the first token-related mode. In S2, the vehicle 2 requests the other vehicle 3 to perform a transfer action via the communication unit 22. In S3, the other vehicle 3 receives, from the user P02, a selection as to whether or not to accept the requested transfer action. When S3 is Yes, the other vehicle 3 notifies the vehicle 2 of the approval by S4. In S5, the other vehicle 3 executes the transfer action. On the other hand, when S3 is No, the other vehicle 3 does not execute S4.

In S6, the vehicle 2 transmits a token to the other vehicle 3 via the communication unit 22. In S7, the other vehicle 3 receives a token from the vehicle 2 and stores the token in the storage unit or the information processing device 1.

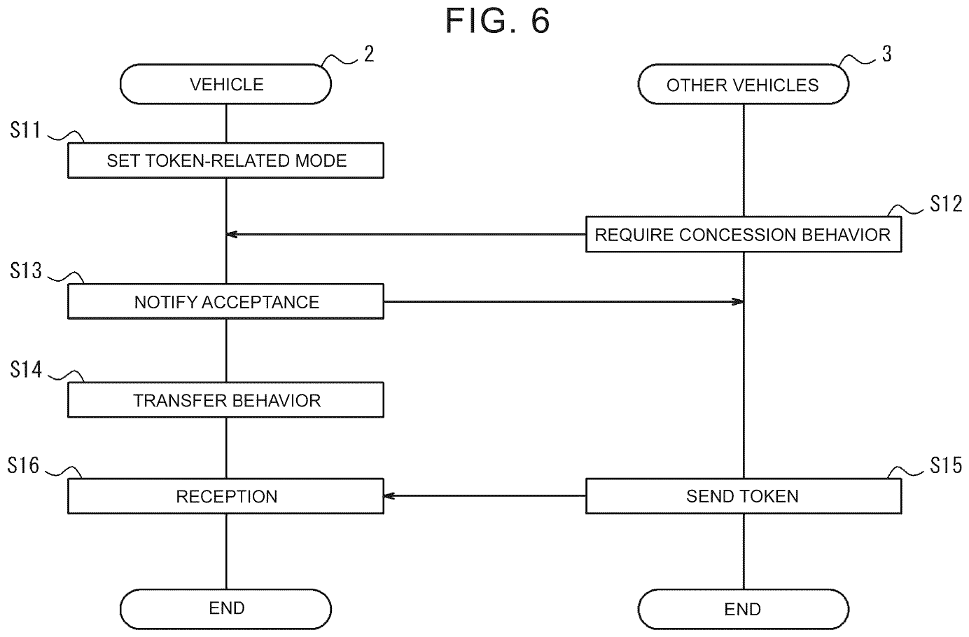

In FIG. 6, a flowchart illustrating an operation performed by the information processing system S when the second token related mode is set in the vehicle 2 will be described.

In S11, the vehicle 2 sets the second token-related mode. In S12, the other vehicle 3 requests the transfer action to the vehicle 2 via the communication unit. The vehicle 2 notifies the other vehicle 3 of the approval by S13, and executes the transfer action by S14. In S15, the other vehicle 3 transmits the token to the vehicle 2 via the communication unit. In S16, the vehicle 2 receives the tokens via the communication unit 22 and store the tokens in the storage unit 23 or the information processing device 1.

As described above, according to the present embodiment, the operation of the control unit 21 executes the operation including setting the token related mode related to the transfer of the token to the vehicle 2. In addition, the operation of the control unit 21 performs an operation including communicating with the other vehicle 3 or the other device via the communication unit 22 in accordance with the token-related mode, and exchanging tokens between the vehicle 2 and the other vehicle 3 or the other device. With this configuration, the control device 2A can transmit a token as an incentive to a participant in the communication. Therefore, it is possible to smoothly promote the transfer action, thereby giving motivation to foster a traffic culture and reduce driver stress.

In addition, according to the present embodiment, the token related mode includes at least one of a mode indicating that the token is preferentially given over on condition that the token is transmitted to the other vehicle 3, a mode indicating that the token is preferentially given over on condition that the token is transmitted, a mode indicating that the token is difficult to be transmitted over, and a mode indicating that the token is transmitted if the token is requested, or a mode indicating that the token is given over if the token is transmitted. With this configuration, the control device 2A can indicate the intention of the vehicle 2, so that smooth communications can be realized.

Further, according to the present embodiment, the operation of the control unit 21 includes determining the number of tokens owned by the vehicle 2, and restricting the settable token-related mode among the plurality of token-related modes in accordance with the number of tokens owned. According to this configuration, the control device 2A is configured to limit the number of modes that can be selected by vehicles.

Further, according to the present embodiment, communication between the vehicle 2 and the other vehicle 3 or the other device is performed directly or indirectly via the roadside device or the information processing device 1. With this configuration, the control device 2A can reliably execute communication.

Although the present disclosure has been described above based on the drawings and the embodiment, it should be noted that those skilled in the art may make various modifications and alterations thereto based on the present disclosure. Other changes may be made without departing from the scope of the present disclosure. For example, the functions included in each means or step can be rearranged so as not to be logically inconsistent, and a plurality of means or steps can be combined into one or divided.

For example, in the above embodiment, a program that executes all or part of the functions or processes of the information processing device 1 can be recorded in a computer-readable recording medium. The computer-readable recording medium includes a non-transitory computer-readable medium such as a magnetic recording device, an optical disc, a magneto-optical recording medium, or a semiconductor memory. The distribution of the program is carried out, for example, by selling, transferring, or renting a portable recording medium such as a digital versatile disc (DVD) or a compact disc read-only memory (CD-ROM) on which the program is recorded. Further, the distribution of the program may be performed by storing the program in a storage of a server and transmitting the program from the server to another computer. Further, the program may be provided as a program product. The present disclosure can also be realized as a program that can be executed by a processor.

What is claimed is:

1. A control device for a vehicle, wherein the control device includes a control unit, a communication unit, and a storage unit, and the control unit executes operation including:
setting the vehicle to a token-related mode related to exchange of a token; and
communicating with another vehicle or another device via the communication unit and exchanging a token between the vehicle and the other vehicle or the other device according to the token-related mode.

2. The control device according to claim 1, wherein the token-related mode includes at least one of:
a mode to indicate a request to be preferentially given way on condition of transmitting a token to the other vehicle;
a mode to indicate an intention to preferentially give way on condition of receiving a token transmitted;
a mode to indicate that it is difficult to give way even if a token is transmitted; and
a mode to indicate an intention to transmit a token if a token is requested, or an intention to give way if a token is transmitted.

3. The control device according to claim 1, wherein the operation includes:
determining a number of tokens possessed by the vehicle; and
restricting a settable token-related mode, among a plurality of token-related modes, according to the number of tokens possessed.

4. The control device according to claim 1, wherein communication between the vehicle and the other vehicle or the other device is performed directly or indirectly via a roadside device or an information processing device.
